(19) United States
(12) Patent Application Publication
(10) Pub. No.: US 2026/0292716 A1
(43) Pub. Date: Sep. 24, 2026

(54) Sounding Reference Signal (SRS) Power Control Enhancement for Multi-Panel Transmission

(71) Applicant: Apple Inc., Cupertino, CA (US)

(72) Inventors: Haitong Sun, Saratoga, CA (US); Dawei Zhang, Saratoga, CA (US); Jie Cui, San Jose, CA (US); Seyed Ali Akbar Fakoorian, San Diego, CA (US); Wei Zeng, Saratoga, CA (US); Xiang Chen, Palo Alto, CA (US)

(21) Appl. No.: 19/472,301

(22) PCT Filed: Apr. 1, 2024
(86) PCT No.: PCT/US2024/022504

§ 371 Date: Oct. 3, 2025

Related U.S. Application Data
(60) Provisional application No. 63/494,672, filed on Apr. 6, 2023.

(51) Int. Cl. H04W 52/36; H04L 5/00; H04W 52/24

(52) U.S. Cl. CPC H04W 52/367; H04L 5/0044; H04L 5/0051; H04W 52/242

(57) ABSTRACT

This disclosure relates to enhanced methods of sounding reference signal (SRS) power control, especially for multi-panel transmissions. Typically, with simultaneous physical uplink shared channel (PUSCH) transmissions, two user equipment (UE) antenna panels are utilized. Different panels may observe different pathloss measurements and/or experience different channel conditions. Therefore, power control enhancement techniques are disclosed herein to address per-panel power control, including: Open Loop Power Control (OLPC) SRS power control enhancement; Closed Loop Power Control (CLPC) SRS power control enhancement; and various MAC CE enhancements for updating one or more SRS Resource sets simultaneously. Enhanced methods may comprise: receiving, at a UE, a configuration of at least one (and preferably two) SRS resource sets for codebook-based (and/or non-codebook-based) PUSCH transmissions (wherein, e.g., the SRS resource sets comprise independently configurable power control parameter sets); and then transmitting a multi-panel transmission to at least one base station, according to the configured SRS resource set(s).

### TECHNICAL FIELD

The present application relates to wireless devices and wireless networks, including devices, circuits, and methods for enhanced Sounding Reference Signals (SRS) power control for multiple-panel transmissions in wireless communication systems.

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

In 5G systems, two different transmission schemes are supported for uplink (UL) transmissions. One transmission scheme is called “codebook-based” transmission, and the other transmission scheme is called “non-codebook-based” transmission. For codebook-based transmission, a user equipment (UE) (e.g., a mobile phone) may be configured with up to one sounding reference signal (SRS) resource set with up to two SRS resources. For non-codebook-based transmission, the UE can be configured with up to one SRS resource set with up to four SRS resources. For each SRS resource, a resource mapping pattern, including: frequency offset, comb and number of symbols, antenna port(s), and time domain behavior (e.g., periodic, aperiodic, or semi-persistent scheduling (SPS) based transmission) can be configured by radio resource control (RRC) signaling. Therefore, different SRS resources can have different configurations. The number of antenna ports configured for a UE could be up to the maximum number of layers the UE can support, which can reflect the UE's capability of number of antenna ports.

Multi-panel UEs may also support so-called simultaneous uplink transmission across multiple panels, or “STxMP.” With STxMP, a UE typically uses two antenna panels, each of which panels may face different observable pathloss and/or channel conditions. Thus, improvements to SRS power control for multi-panel transmissions are desired.

### SUMMARY

In accordance with one or more aspects, a method of power control enhancement for multi-panel user equipment (UE) transmissions is disclosed, the method comprising: receiving, at a UE, a configuration of at least one of: a first sounding reference signal (SRS) resource set for codebook-based physical uplink shared channel (PUSCH) transmissions; and a second SRS resource set for non-codebook-based PUSCH transmissions; and transmitting a multi-panel transmission from the UE to at least one base station according to at least one of the first SRS resource set and the second SRS resource set.

According to some aspects, the method further comprises receiving, at the UE, a configuration of a third SRS resource set for codebook-based PUSCH transmissions, wherein the first SRS resource set is mapped to a first antenna panel of the UE, wherein the third SRS resource set is mapped to a second antenna panel of the UE, and wherein the multi-panel transmission is made according to the first SRS resource set and the third SRS resource set.

According to other aspects, the method further comprises receiving, at the UE, a configuration of a fourth SRS resource set for non-codebook-based PUSCH transmissions, wherein the second SRS resource set is mapped to a first antenna panel of the UE, wherein the fourth SRS resource set is mapped to a second antenna panel of the UE, and wherein the multi-panel transmission is made according to the second SRS resource set and the fourth SRS resource set.

According to some aspects, at least one of the first SRS resource set and the second SRS resource set comprises an independently configurable power control parameter set, e.g., comprising at least one of the following parameters: alpha (for partial or full pathloss compensation); P0 (a target receive power at a base station receiver); and pathlossReferenceRS (a reference signal to be used for pathloss estimation).

According to some aspects, either a single set of power control parameters (or two sets of power control parameters) may be configured for the first SRS resource set (or for the second SRS resource set, i.e., in the case of non-codebook-based PUSCH transmissions). In the case of two sets of power control parameters being configured for the first (or second) SRS resource set, at least one of: the alpha parameter, P0 parameter or pathlossReferenceRS parameter may be individually configured for each of the two sets of power control parameters.

According to other aspects, at least the pathlossReferenceRS parameter may be individually updated, via a MAC CE, for each of the two sets of power control parameters that are configured for the first (or second) SRS resource set. According to such aspects, the MAC CE may further comprise one or more of: an indication of a serving cell ID that contains the first (or second) SRS resource set; an indication of a bandwidth part (BWP) that contains the first (or second) SRS resource set; or an identifier for the first (or second) SRS resource set.

According to aspects wherein a codebook-based multi-panel transmission is made according to the first SRS resource set and the third SRS resource set, the pathlossReferenceRS parameter may individually updated, via MAC CE, for each of the first SRS resource set and/or the third SRS resource set. According to such aspects, the MAC CE may further comprise one or more of: an indication of a serving cell ID that contains the first or third SRS resource sets; an indication of a BWP that contains the first or third SRS resource sets; an identifier for the first SRS resource set; or an identifier for the third SRS resource set.

Likewise, for non-codebook-based transmission, wherein the multi-panel transmission is made according to the second SRS resource set and the fourth SRS resource set, the pathlossReferenceRS parameter may individually updated, via MAC CE, for each of the second SRS resource set and/or the fourth SRS resource set. According to such aspects, the MAC CE may further comprise one or more of: an indication of a serving cell ID that contains the second or fourth SRS resource sets; an indication of a BWP that contains the second or fourth SRS resource sets; an identifier for the second SRS resource set; or an identifier for the fourth SRS resource set.

According to still other aspects, a first one of two sets of power control parameters that are configured for the first (or second) SRS resource set may configure a first P0 parameter, while a second one of the two sets of power control parameters that are configured for the first (or second) SRS resource set may configure a second P0 parameter.

According to yet other aspects, a first transmit power (T0) may be calculated based on a first one of the two sets of power control parameters that are configured for the first (or second) SRS resource set, a second transmit power (T1) may be calculated based on a second one of the two sets of power control parameters that are configured for the first (or second) SRS resource set, and a target transmit power for a multi-panel transmission according to the first (or second) SRS resource set is configured to be one of: (a) a maximum value between T0 and T1; or (b) a minimum value between T0 and T1.

According to still yet other aspects, a target transmit power for a multi-panel transmission according to a first one or more of the SRS resources in the first (or second) SRS resource set is configured to be TO, while a target transmit power for the multi-panel transmission according to a second one or more of the SRS resources in the first (or second) SRS resource set is configured to be T1.

In accordance with one or more further aspects, a method of power control enhancement for multi-panel UE transmissions is disclosed, the method comprising: receiving, at a UE, a transmit power control (TPC) command (e.g., in DCI Format 2_3) containing configuration information for each of: a first antenna panel of the UE; and a second antenna panel of the UE; and transmitting a multi-panel transmission from the UE to at least one base station using the first antenna panel and the second antenna panel, according to at least a first SRS resource and the TPC command.

According to other aspects, a first SRS resource may be mapped to the first antenna panel of the UE, while a second SRS resource may be mapped to the second antenna panel of the UE, and then, the TPC command may be applied to both of the first SRS resource and the second SRS resource, i.e., so that the TPC command may be used with both the first and second antenna panels of the UE.

According to still other aspects, a first portion of the TPC command (e.g., a single bit, or two or more bits) contains configuration information that is applied to the first antenna panel of the UE, while a second portion of the TPC command (e.g., a single bit, or two or more bits) contains configuration information that is applied to the second antenna panel of the UE.

The various methods and techniques summarized in this section may likewise be performed by a device comprising: a receiver; a transmitter; and a processor configured to perform any of the various methods and techniques summarized herein. The various methods and techniques summarized in this section may likewise be stored as instructions in a non-transitory computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5 illustrates an exemplary UE configured for multi-panel transmission, according to some aspects.

FIG. 6A illustrates exemplary determined transmit powers to be used with various SRS resources in an SRS resource set, according to some aspects.

FIG. 6B illustrates various MAC CE enhancements for multi-panel transmission power control, according to some aspects.

FIG. 7A is a flowchart detailing a method of performing enhanced open loop power control (OLPC) for multi-panel transmissions, according to some aspects.

FIG. 7B is a flowchart illustrating further details for a method of performing enhanced OLPC for multi-panel transmissions using MAC CE, according to some aspects.

FIG. 8 is a flowchart detailing a method of performing enhanced closed loop power control (CLPC) for multi-panel transmissions, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

In the current Release 17 of the 3GPP NR specification, for SRS power control, a power control parameter set may be configured for an SRS resource set including several parameters, such as: an alpha parameter (i.e., a parameter for partial or full pathloss compensation); a P0 parameter (i.e., a target receive power at a base station receiver); and a pathlossReferenceRS parameter (i.e., a reference signal to be used for pathloss estimation). Furthermore, a special transmit power control (TPC) command for closed loop power control (CLPC) may be indicated, e.g., by DCI Format 2_3.

As further specified in the current Release 17 of the 3GPP NR specification, for physical uplink shared channel (PUSCH) power control, power control parameters may be indicated by the SRS resource indicator (SRI) field. In PUSCH power control, one or multiple “SRI-PUSCH-PowerControl” instances can be configured. Each SRI-PUSCH-PowerControl instance may be mapped to one SRI value. Furthermore, TPC commands for close loop power control (CLPC) may be indicated by DCI Formats 0_1, 0_2, and/or 2_2.

In the RAN1 #110 meeting, it was agreed that NR would support a single downlink control information (DCI)-based simultaneous PUSCH transmission with spatial domain multiplexing (SDM). Typically, with simultaneous PUSCH transmission, two antenna panels are needed, and, therefore, per-panel power control becomes an important consideration for future standards designs.

Thus, the present application relates to various solutions for SRS power control enhancement for multi-panel transmission, including: Open Loop Power Control (OLPC) SRS power control enhancement; Closed Loop Power Control (CLPC) SRS power control enhancement; and various MAC CE enhancements for updating one or more SRS Resource sets simultaneously.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

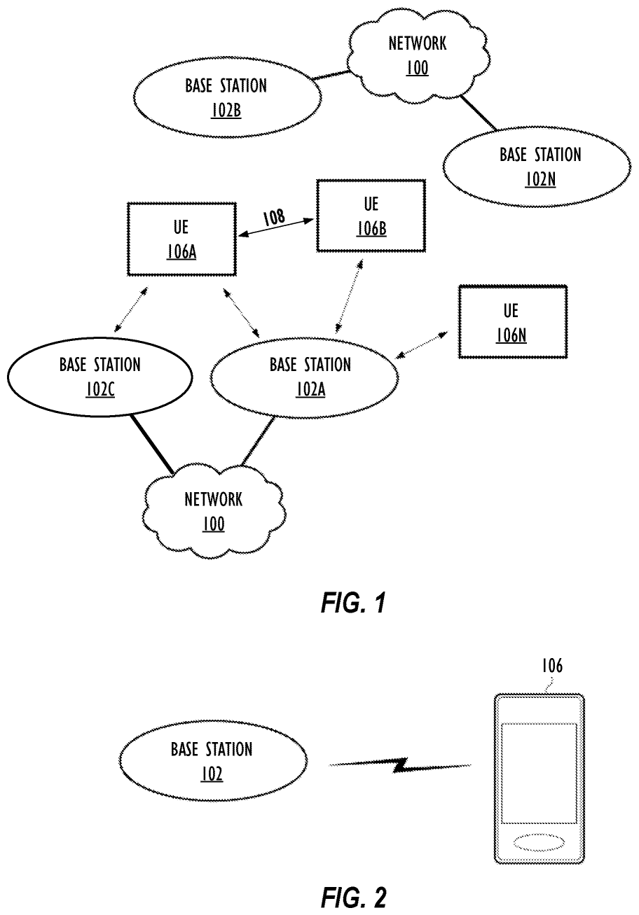

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

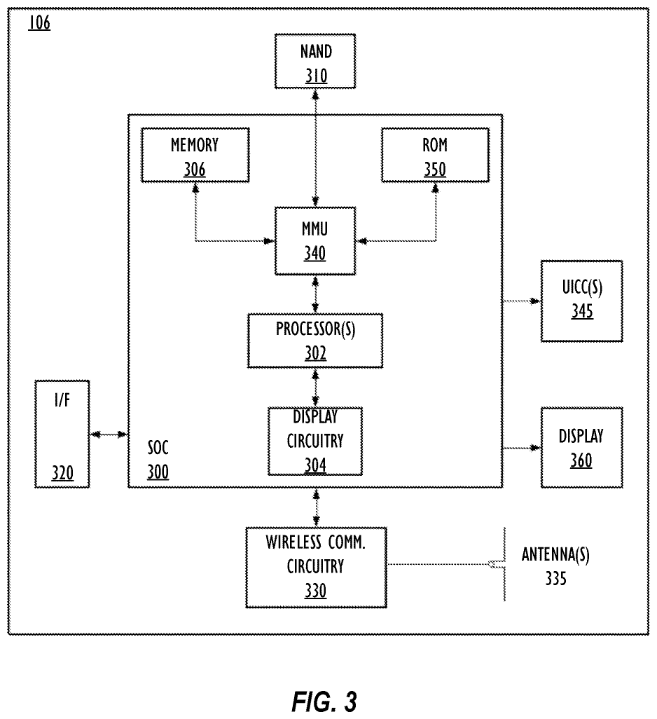

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1,2,4, or 8).

### Example Communication Device

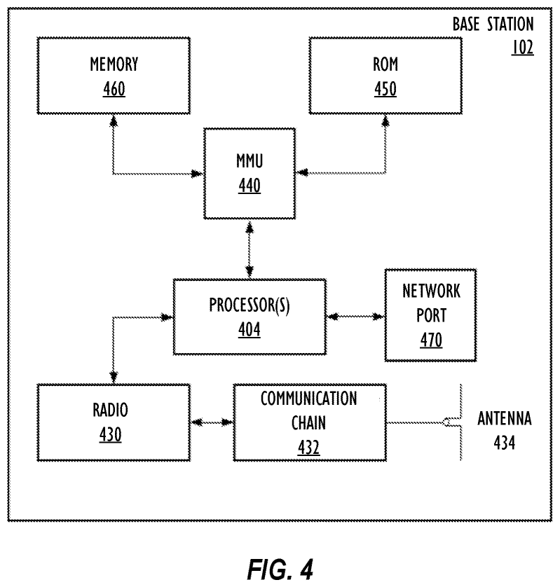

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 (each of which may include an antenna panel), as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

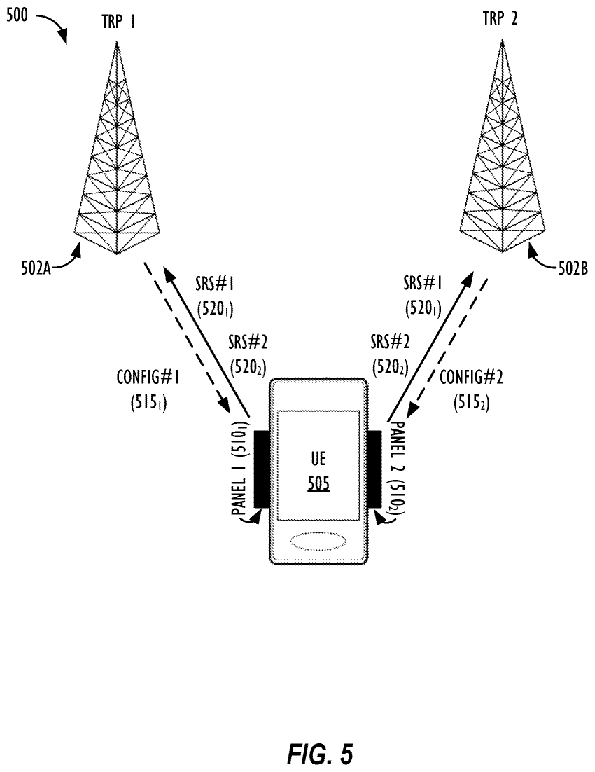

FIG. 4 illustrates an example block diagram of a base station 102, according to some aspects. It is noted that the base station of FIG. 4 is a non-limiting example of a possible base station. As shown, the base station 102 may include processor(s) 304 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas or antenna panels. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mm Wave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Multi-Panel User Equipment (UE) Communications

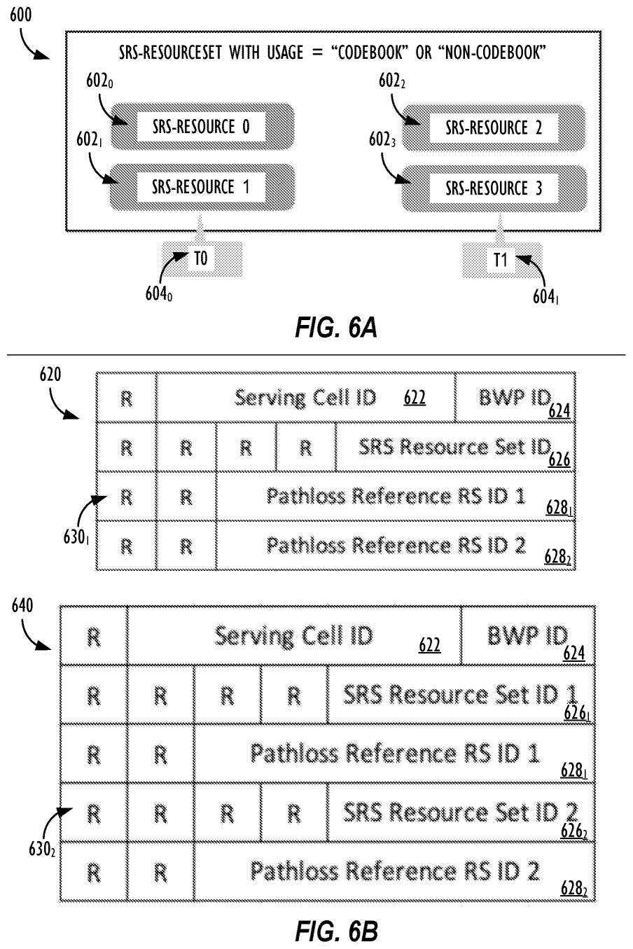

Turning now to FIG. 5, an example 500 of a UE 505 configured for multi-panel transmission is shown, according to some aspects. In the system 500 of FIG. 5, two antenna panels 5101 and 5102 are included on the UE 505. A multi transmission reception point (mTRP) operation, involving two TRPs (i.e., TRP #1 502A and TRP #2 502B) that are configured to communicate with the UE 505, is shown in FIG. 5. The solid lines indicate the uplink (UL), over which one or more SRS signals (5151/5152) may be transmitted to each TRP (e.g., after STxMP communication is established by RRC configuration), while the dashed lines indicate the downlink (DL), over which SRS resource set configurations may be received by UE 505, e.g., via RRC configuration.

### Open Loop Power Control (OLPC) SRS Power Control Enhancement

In traditional OLPC, there is no feedback from either a UE to a base station- or from a base station to a UE. For example, the base station may transmit a target receive power at the gNB (i.e., P0) to a UE. The UE receives the target power and, based on this parameter and other pathloss measurements and/or channel conditions, the UE adjusts the transmit power accordingly. As mentioned above, different panels on a UE may observe different pathloss measurements and/or experience different channel conditions. Therefore, power control enhancement techniques for multi-panel SRS transmission are needed.

According to some aspects, for multi-panel SRS transmission, for codebook-based PUSCH transmissions, two SRS resource sets with usage set to “codebook” are configured. Similarly, for non-codebook-based PUSCH transmissions, two SRS resource sets with usage set to “nonCodebook” are configured. According to such aspects, each SRS resource set may be mapped to a different antenna panel. Moreover, each SRS resource set may be independently configured with different power control parameter sets, including at least one of the following parameters: an alpha parameter (for partial or full pathloss compensation); a P0 parameter (i.e., a target receive power at a base station receiver); and a pathlossReferenceRS parameter (a reference signal to be used for pathloss estimation).

According to other aspects, for multi-panel SRS transmission, for codebook-based PUSCH transmissions, a single SRS resource set with usage set to “codebook” may be configured. Similarly, for non-codebook-based PUSCH transmissions, a single SRS resource set with usage set to “nonCodebook” may be configured. In cases where only a single SRS resource set is configured, there may be either a single set of power control parameters configured for the single SRS resource set, or there may be at least two sets of power control parameters (e.g., different sets of parameters) configured for the single SRS resource set. In such cases, the additional (e.g., different) parameter for the second set of power control parameters may be the pathlossReferenceRS parameter (and may also include different alpha and/or P0 parameter values, if desired).

A sample SRS resource set definition with multiple sets of power control parameters is shown below:

```
SRS-ResourceSet ::= SEQUENCE {
  srs-ResourceSetId SRS-ResourceSetId,
  srs-ResourceIdList SEQUENCE (SIZE(1..maxNrofSRS-ResourcesPerSet)) OF SRS-
  ResourceId OPTIONAL, -- Cond Setup
  ...
  alpha Alpha OPTIONAL, -- Need S
  p0 INTEGER (−202..24) OPTIONAL, -- Cond Setup
  pathlossReferenceRS PathlossReferenceRS-Config OPTIONAL, -- Need M
  alpha2 Alpha OPTIONAL, -- Need S
  p02 INTEGER (−202..24) OPTIONAL, -- Cond Setup
  pathlossReferenceRS2 PathlossReferenceRS-Config OPTIONAL, -- Need M
  ...
}
```

In cases where multiple sets of power control parameters are configured for a single SRS resource set (for either “codebook” or “non-codebook”), according to some aspects, the first set of power control parameters (e.g., alpha, p0, pathlossReferenceRS, as shown in the example above) may be used to determine a first transmit power, T0, while the second set of power control parameters (e.g., alpha2, p02, pathlossReferenceRS2, as shown in the example above) may be used to determine a different second transmit power, T1.

According to some such aspects, a single transmit power may then be used for all the SRS resources in the SRS resource set (e.g., T0, T1, max (T0, T1), min (T0, T1), mean (T0, T1), etc.). For example, in some cases, using the maximum of T0 and T1 may be preferable, so that both panels can reach their targets, however, it may also cause the UE to expend more power than if the minimum value of T0 and T1 were selected.

According to other aspects, the first transmit power, TO, may be used for some of the SRS resources in the in the SRS resource set, and the second transmit power, T1, may be used for other ones of the SRS resources in the in the SRS resource set.

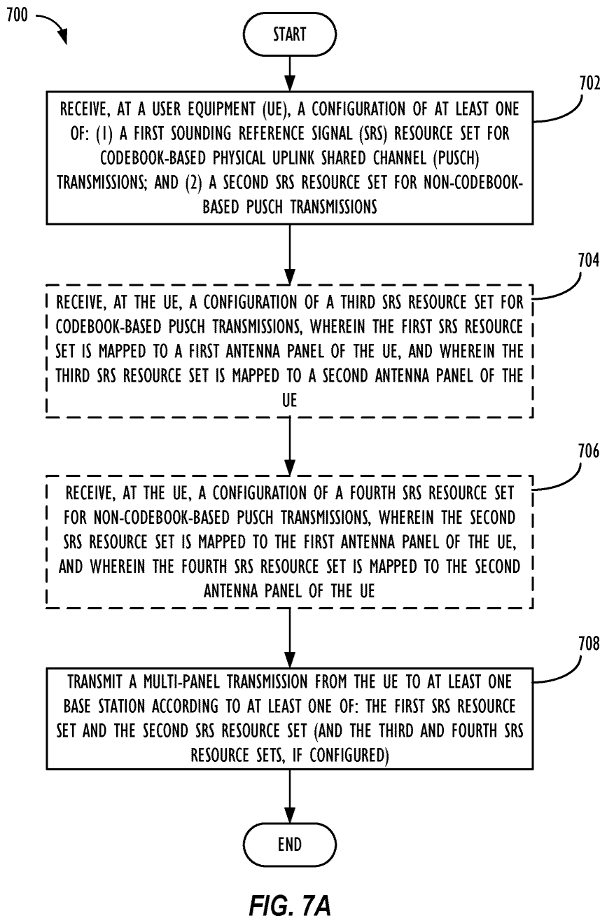

FIG. 6A illustrates such a scenario, wherein exemplary determined transmit power T0 (6040) is used with SRS resources 602₀ and 602₁ in SRS resource set 600, and exemplary determined transmit power T1 (6041) is used with SRS resources 602₂ and 602₃ in SRS resource set 600.

As another example of the way that determined transmit powers (e.g., T0/T1) may be assigned to various SRS resources in an SRS resource set, two SRS resource ID lists may be configured within an SRS resource set, and the SRS resources within the first SRS resource ID list may use the T0 transmit power, while the SRS resources within the second SRS resource ID list may use the T1 transmit power.

As yet another example, a list of one or multiple pairs of SRS resources may be configured within an SRS resource set, and the first SRS resource in each pair may use the T0 transmit power, while the second SRS resource in each pair may use the T1 transmit power. Other variations and assignments of determined transmit powers to SRS resources within an SRS resource set are also possible, based on the needs of a given implementation.

### MAC CE Enhancements for SRS Power Control

Returning to the examples described above, wherein, for multi-panel SRS transmission, a single SRS resource set is configured (either “codebook” or “non-codebook”) and two distinct sets of power control parameters are configured for the same SRS resource set, according to some aspects, MAC CE may be used as the method of updating the SRS resource set with two different pathlossReferenceRS IDs.

Turning now to FIG. 6B an exemplary MAC CE 620, which may be used for updating a first SRS resource set with two different pathlossReferenceRS IDs, is illustrated. Exemplary MAC CE 620 may comprise fields for: an indication of a serving cell ID that contains the first SRS resource set (622); an indication of a bandwidth part (BWP) that contains the first SRS resource set (624); and an identifier for the first SRS resource set (626). The exemplary MAC CE 620 may also comprise fields for an ID for the first pathloss reference RS (628₁) and an ID for the second pathloss reference RS (628₂). The MAC CE 620 may also comprise one or more reserved bits, R (6301), which may be reserved for future uses (and/or OCTET alignment of the MAC-CE payload) and be set to 0.

Returning now to the examples described above, wherein, for multi-panel SRS transmission, when two SRS resource sets are configured (either “codebook” or “non-codebook”) and each SRS resource set maps to a different antenna panel of the UE, according to some aspects, MAC CE may be used as the method of updating the two SRS resource sets simultaneously.

Returning now to FIG. 6B another exemplary MAC CE 640, which may be used for updating a first and a second SRS resource set with two different pathlossReferenceRS IDs, is illustrated. Exemplary MAC CE 640 may comprise fields for: an indication of a serving cell ID that contains the activated SRS resource set (622); an indication of a bandwidth part (BWP) that contains the activated SRS resource set (624); and identifiers for the first SRS resource set (626₁) and the second SRS resource set (626₂). The exemplary MAC CE 640 may also comprise fields for an ID for the first pathloss reference RS (628₁) for the first SRS resource set and an ID for the second pathloss reference RS (628₂) for the second SRS resource set. The MAC CE 640 may also comprise one or more reserved bits, R (630₂), which may be reserved for future uses (and/or OCTET alignment of the MAC-CE payload) and be set to 0.

As may now be understood, using a since MAC CE such as 640, which is capable of updating parameters for two different SRS resource sets simultaneously may be more efficient then sending two different MAC CE, such as is shown in the example 620, to achieve the same updating of multiple SRS resource sets.

### Closed Loop Power Control (CLPC) SRS Power Control Enhancement

Closed Loop Power Control is a mechanism by which PUSCH (or PUCCH or SRS) channel power may be controlled while a UE is in communication (i.e., is connected) with a base station. For example, via the use of a TPC command (e.g., for DCI Format 2_3), a base station may indicate to a UE how much its transmit power should be reduced or increased. For example, an “accumulation” TPC mode may be used, wherein a UE uses memory to keep track of its prior power state and then increases (or reduces) its power state based on the latest value received in a TPC command. As another example, an “absolute” TPC mode may be used, wherein a UE is provided with a total power value to utilize (and does not need to recall or modify a previously stored power state).

According to some aspects disclosed herein, TPC commands may also be applied to multi-panel transmission scenarios. For a first option, the TPC command received in DCI Format 2_3 may be applied to both an SRS resource mapped to a first antenna panel of a UE and an SRS resource mapped to a second antenna panel of the UE (whether or not the SRS resources are part of a same SRS resource set or different SRS resource sets). As a second option, the TPC command may be split into two portions, wherein a first portion of the TPC command contains configuration information that is applied to the first antenna panel of the UE, and a second portion of the TPC command contains configuration information that is applied to the second antenna panel of the UE. For example, in the case of a 2-bit TPC command (wherein, in traditional single panel transmissions, ‘00’ may indicate to decrease the transmit power by 1 dB, ‘01’ may indicate to keep the transmit power level the same, ‘10’ may indicate to increase the transmit power by 1 dB, and ‘11’ may indicate to increase the transmit power by 3 dB), the first bit may instead be applied to the SRS resource that is mapped to the first antenna panel of the UE (wherein, e.g., a first bit value of ‘0’ may indicate to decrease transmit power of the first antenna panel, and a first bit value of ‘1’ may indicate to increase transmit power of the first antenna panel), and the second bit may be applied to the SRS resource that is mapped to the second antenna panel of the UE (wherein, e.g., a second bit value of ‘0’ may indicate to decrease transmit power of the second antenna panel, and a second bit value of ‘1’ may indicate to increase transmit power of the second antenna panel). If no change in transmit power is needed during a given time interval, a base station may simply choose not to transmit a bit for the respective antenna panel.

As another example, an additional 2-bit TPC command may be introduced, whereby the existing 2-bit TPC command may be applied to the SRS resource mapped to the first panel of the UE, and the additional 2-bit TPC may be applied to the SRS resource mapped to the second panel of the UE. Other means of coding TPC information (e.g., using more than 2 bits, or applying to more than 2 panels, etc.) for the various panels of a UE that is engaged in multi-panel transmissions are also possible, based on the needs of a given implementation.

### Exemplary Methods

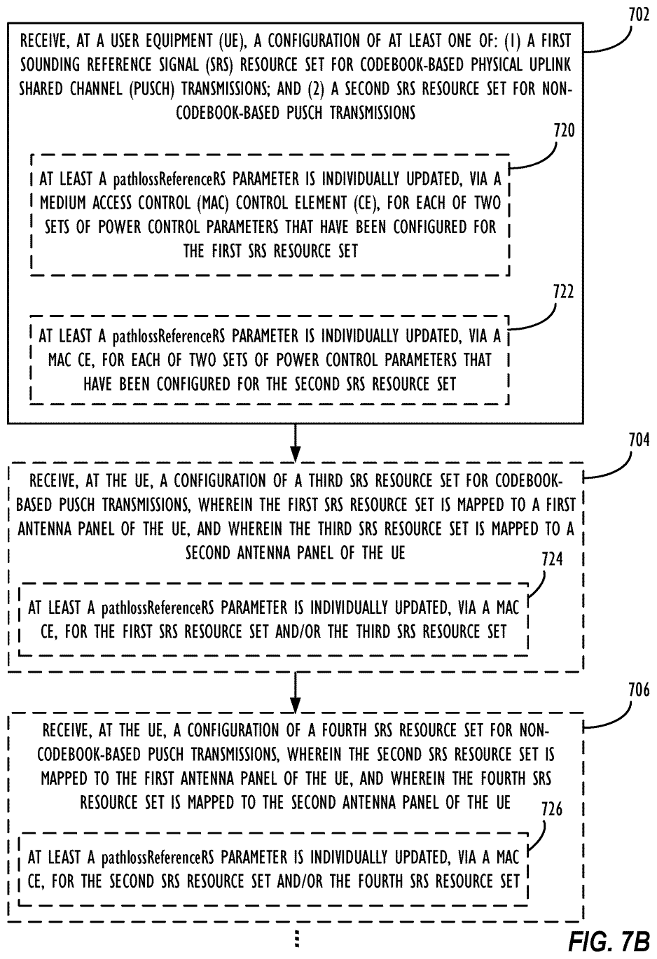

Turning now to FIG. 7A, a flowchart detailing a method 700 of performing enhanced open loop power control (OLPC) for multi-panel transmissions is shown, according to some aspects. First, at block 702, the method 700 may receive, at a UE, a configuration of at least one of: (1) a first sounding reference signal (SRS) resource set for codebook-based physical uplink shared channel (PUSCH) transmissions; and (2) a second SRS resource set for non-codebook-based PUSCH transmissions. Next, at block 704, the method 700 may optionally receive, at the UE, a configuration of a third SRS resource set for codebook-based PUSCH transmissions, wherein the first SRS resource set is mapped to a first antenna panel of the UE, and wherein the third SRS resource set is mapped to a second antenna panel of the UE.

At block 706, the method 700 may optionally receive at the UE, a configuration of a fourth SRS resource set for non-codebook-based PUSCH transmissions, wherein the second SRS resource set is mapped to the first antenna panel of the UE, and wherein the fourth SRS resource set is mapped to the second antenna panel of the UE. While block 704 and block 706 are described as optional steps, a typical case may be that only one of code-booked-based or non-codebook-based transmissions are configured for a given UE, e.g., either two SRS resource sets are configured for “codebook,” or two SRS resource sets are configured for “non-codebook.” In other implementations, it may also be possible to configure SRS resource sets for both “codebook” and “non-codebook”-based PUSCH transmissions.

Finally, at block 708, the method 700 may transmit a multi-panel transmission from the UE to at least one base station according to at least one of: the first SRS resource set and the second SRS resource set (i.e., whichever one happens to currently be configured). As may be understood, the transmission may also be made according to the third and/or fourth SRS resource sets, too (i.e., if either one is currently configured).

Turning now to FIG. 7B, a flowchart illustrating further details for the method 700 of performing enhanced OLPC for multi-panel transmissions using MAC CE is shown, according to some aspects. First, returning to block 702, the method of 700 may, at block 720, optionally individually update at least a pathlossReferenceRS parameter, via a MAC CE, for each of two sets of power control parameters that have been configured for the first SRS resource set (i.e., for codebook-based transmissions). Likewise, at block 722, method 700 may optionally individually update at least a pathlossReferenceRS parameter, via a MAC CE, for each of two sets of power control parameters that have been configured for the second SRS resource set (i.e., for non-codebook-based transmissions).

Next, returning to block 704, the method 700 may, at block 724, optionally individually update at least a pathlossReferenceRS parameter, via a MAC CE, for the first SRS resource set and/or the third SRS resource set (i.e., for codebook-based transmissions where two SRS resource sets have been configured). That is, the first and third SRS resource sets may be independently updated via the same MAC CE or with separate MAC-CE. Likewise, returning to block 706, the method 700 may, at block 726, optionally individually update at least a pathlossReferenceRS parameter, via a MAC CE, for the second SRS resource set and/or the fourth SRS resource set (i.e., for non-codebook-based transmissions where two SRS resource sets have been configured). That is, the second and fourth SRS resource sets may be independently updated via the same MAC CE or with separate MAC-CE.

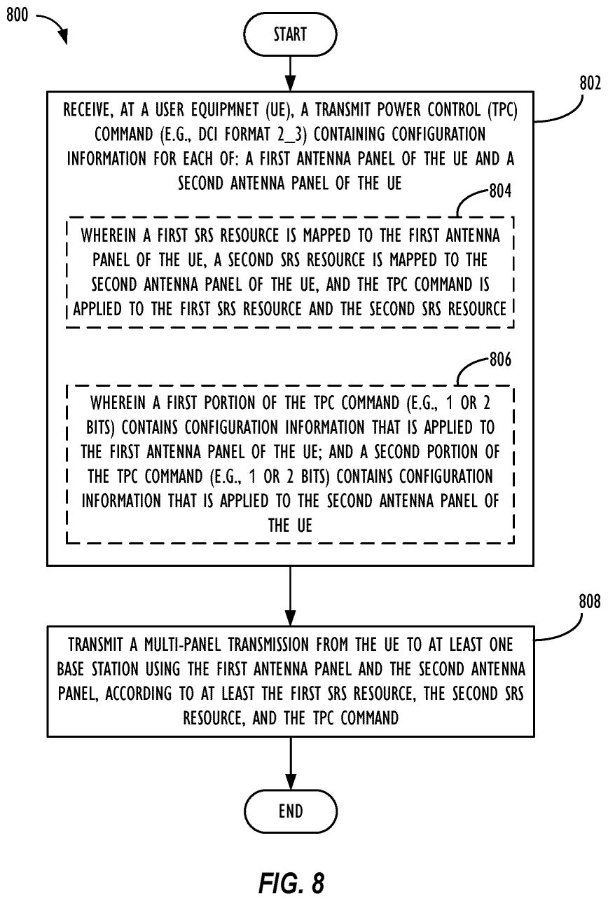

Turning now to FIG. 8, a flowchart detailing a method 800 of performing enhanced closed loop power control (CLPC) for multi-panel transmissions is shown, according to some aspects. First, at block 802, the method 800 may receive, at a UE, a transmit power control (TPC) command (e.g., in DCI Format 2_3) containing configuration information for each of: a first antenna panel of the UE and a second antenna panel of the UE.

Next, at block 804, the method 800 may optionally map a first SRS resource to the first antenna panel of the UE, map a second SRS resource to the second antenna panel of the UE, and then apply the TPC command to both of the first SRS resource and the second SRS resource (i.e., such that said TPC command, e.g., to increase or decrease power, is utilized by both the first and second antenna panels of the UE). It is to be understood that the first and second SRS resources may be from the same SRS resource set, or they may be from different SRS resource sets.

At block 806, the method 800 may optionally extract a first portion of the TPC command (e.g., 1 or 2 bits) that contains configuration information that is to be applied to the first antenna panel of the UE; and extract a second portion of the TPC command (e.g., a different 1 or 2 bits than the first portion) that contains configuration information that is to be applied to the second antenna panel of the UE. For example, the TPC command could contain information specifying: for the first antennal panel of the UE to increase its power and the second antenna panel of the UE to decrease its power; for the first antennal panel of the UE to decrease its power and the second antenna panel of the UE to increase its power; for both antennal panels of the UE to increase their power; for both antennal panels of the UE to decrease their power; for both antennal panels of the UE to remain at the same power, etc.

Finally, at block 808, the method 800 may transmit a multi-panel transmission from the UE to at least one base station using the first antenna panel and the second antenna panel, according to at least the first SRS resource, the second SRS resource, and the TPC command.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A method of power control enhancement for a multi-panel user equipment (UE), the method comprising:
receiving a configuration of at least one of:
a first sounding reference signal (SRS) resource set for codebook-based physical uplink shared channel (PUSCH) transmissions; and
a second SRS resource set for non-codebook-based PUSCH transmissions; and
transmitting a multi-panel transmission to at least one base station according to at least one of the first SRS resource set and the second SRS resource set.

2. The method of claim 1, further comprising:
receiving a configuration of a third SRS resource set for codebook-based PUSCH transmissions,
wherein the first SRS resource set is mapped to a first antenna panel of the UE,
wherein the third SRS resource set is mapped to a second antenna panel of the UE, and
wherein the multi-panel transmission is made according to the first SRS resource set and the third SRS resource set.

3. The method of claim 1, further comprising:
receiving a configuration of a fourth SRS resource set for non-codebook-based PUSCH transmissions,
wherein the second SRS resource set is mapped to a first antenna panel of the UE,
wherein the fourth SRS resource set is mapped to a second antenna panel of the UE, and
wherein the multi-panel transmission is made according to the second SRS resource set and the fourth SRS resource set.

4. The method of claim 1, wherein at least one of the first SRS resource set and the second SRS resource set comprises an independently configurable power control parameter set.

5. The method of claim 4, wherein the independently configurable power control parameter set comprises at least one of the following parameters:
alpha;
P0; and
pathlossReferenceRS.

6. The method of claim 1, wherein a single set of power control parameters is configured for the first SRS resource set.

7. The method of claim 1, wherein two sets of power control parameters are configured for the first SRS resource set.

8. The method of claim 7, wherein at least one of:
an alpha parameter;
a P0 parameter; or
a pathlossReferenceRS parameter
is individually configured for each of the two sets of power control parameters that are configured for the first SRS resource set.

9.-15. (canceled)

16. The method of claim 1, wherein a single set of power control parameters is configured for the second SRS resource set.

17. The method of claim 1, wherein two sets of power control parameters are configured for the second SRS resource set.

18. The method of claim 17, wherein at least one of:
an alpha parameter;
a P0 parameter; or
a pathlossReferenceRS parameter
is individually configured for each of the two sets of power control parameters that are configured for the second SRS resource set.

19. (canceled)

20. (canceled)

21. The method of claim 3, wherein at least a pathlossReferenceRS parameter is individually updated, via a Medium Access Control (MAC) Control Element (CE), for the second SRS resource set and/or the fourth SRS resource set.

22. (canceled)

23. The method of claim 17, wherein:
a first one of the two sets of power control parameters that are configured for the second SRS resource set configures a first P0 parameter; and
a second one of the two sets of power control parameters that are configured for the second SRS resource set configures a second P0 parameter.

24. (canceled)

25. The method of claim 17, wherein:
a first transmit power (T0) is calculated based on a first one of the two sets of power control parameters that are configured for the second SRS resource set,
a second transmit power (T1) is calculated based on a second one of the two sets of power control parameters that are configured for the second SRS resource set,
a target transmit power for a multi-panel transmission according to a first one or more of the SRS resources in the second SRS resource set is configured to be T0, and
a target transmit power for the multi-panel transmission according to a second one or more of the SRS resources in the second SRS resource set is configured to be T1.

26.-32. (canceled)

33. A multi-panel user equipment (UE) device comprising:
a receiver;
a transmitter; and
a processor configured to cause the UE to:
receive a configuration of at least one of:
a first sounding reference signal (SRS) resource set for codebook-based physical uplink shared channel (PUSCH) transmissions; and
a second SRS resource set for non-codebook-based PUSCH transmissions; and
transmitting a multi-panel transmission to at least one base station according to at least one of the first SRS resource set and the second SRS resource set.

34. (canceled)

35. A baseband processor configured to cause a multi-panel user equipment (UE) device to
receive a configuration of at least one of:
a first sounding reference signal (SRS) resource set for codebook-based physical uplink shared channel (PUSCH) transmissions; and
a second SRS resource set for non-codebook-based PUSCH transmissions; and
transmitting a multi-panel transmission to at least one base station according to at least one of the first SRS resource set and the second SRS resource set.

36. The UE of claim 33, wherein two sets of power control parameters are configured for the first SRS resource set.

37. The UE of claim 36, wherein:
a first one of the two sets of power control parameters that are configured for the second SRS resource set configures a first P0 parameter; and
a second one of the two sets of power control parameters that are configured for the second SRS resource set configures a second P0 parameter.

38. The baseband processor of claim 35, wherein two sets of power control parameters are configured for the first SRS resource set.

39. The baseband processor of claim 38, wherein:
a first one of the two sets of power control parameters that are configured for the second SRS resource set configures a first P0 parameter; and
a second one of the two sets of power control parameters that are configured for the second SRS resource set configures a second P0 parameter.
